(19) United States
(12) Patent Application Publication
(10) Pub. No.: US 2006/0212850 A1
(43) Pub. Date: Sep. 21, 2006

(54) Method of iterative recursive flattening of a high level verification language hierarchy

(76) Inventor: Matthew P. Potts, Citrus Heights, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/083,903

(22) Filed: Mar. 18, 2005

(51) Int. Cl. G06F 9/44

(52) U.S. Cl. 717/126

(57) ABSTRACT

A preferred embodiment of the present invention is disclosed for flattening a tree-like hierarchical software program structure having multiple levels that import files from other locations, that comprises parsing the program structure to identify each instance in which the program imports code from another location in said program structure, creating an import file for each instance in which code is imported, each import file containing code that is operational to only import code from another location, and consolidating all import files into a consolidated import file, whereby the non-import files are substantially on a single hierarchical level immediately below the consolidated import file.

### BACKGROUND OF THE INVENTION

The present invention generally relates to the design and testing of integrated circuits.

When an integrated circuit chip is designed, such as an application specific integrated circuit (ASIC) or microprocessor or the like, designers generally use Verilog or some similar high level design language. Before an integrated circuit is ever actually made in silicon, the design must be tested to determine if it will work as intended. Such testing is carried out in a simulation that is carried out by a high level verification language program such as e,. marketed by the Verisity Corporation of Mountain View, Calif.

When a simulation is run, the design created by the designers requires stimulus to be applied to the design. The e program contains a set of code to describe all of the rules that apply to a simulation, i.e., all the rules that apply to the stimulus and configuration. The stimulus is usually written by the same people who write the test cases. The result is a set of code that simulates the design, but is written in the verification language e, rather than the design language.

As is known to those skilled in the art, the design language is converted directly into circuits that are manufactured, whereas the verification language is a higher level language that does not require detailed coding, but permits one to describe the rules and behaviors. The verification code therefore does not require as much time to write as is required to write the coding for the actual design itself. However, the verification code is meant to behave and to understand the behavior of the actual design.

The structure is largely at the discretion of the designers using it, but for high level verification language, it is very hierarchical, which means

The structure is largely at the discretion of the designers using it, but for high level verification language, it is very hierarchical, which means that smaller pieces of code on a low level can be pulled up to a higher level. For example, code can be written that describes how a port of a large network switch behaves. But if there are 10 ports on a switch, instead of having to write the code 10 times, a piece of code which can be considered to be an object, can be written that describes what a port is, but does not know which port it is. If there is a switch chassis that has a number of cards, and each card has a number of ports, it is evident that a hierarchy is created. A card may not know its own identity, but it knows what ports it has. Each port may not know its identity, but the card knows the identification of its ports. Similarly, the chassis knows the identity of the cards that are mounted in it.

The verification code also preferably contains an object that defines a packet. All of the characteristics of a packet are defined in an object of the verification code. While the code itself does not know what the actual data is that is in the packet, it does know all of the rules about the data that goes into a packet. In another location in the code, the kind of stimulus that is desired is present and that kind of stimulus sets the actual data that is placed in the packet.

A hierarchy therefore exists relating to the chassis, cards and ports and there are also rules about the stimulus that is to be applied during the test case. The combination of all of the necessary code becomes the code that is used in the verification language, i.e., the high level verification language comprises the whole set of code that describes all of the rules.

The way that e or almost any other verification language is structured is that any piece of code can pull in any other piece of code from anywhere. If there were no rules about it, there is a danger that code would be generated that would create circularity or loops, pulling in other code that would quickly produce errors. In the absence of controls or rules, any piece of code could pull in any other piece of code and the writer would not know it was happening. It is for this reason that code is normally written in the structure of a tree, i.e., there is a top level file that includes other files, and those files may include other files.

### SUMMARY OF THE INVENTION

A preferred embodiment of the present invention is disclosed for flattening a tree-like hierarchical software program structure having multiple levels that import files from other locations, that comprises parsing said program structure to identify each instance in which the program imports code from another location in said program structure, creating an import file for each instance in which code is imported, each import file containing code that is operational to only import code from another location, and consolidating all import files into a consolidated import file, whereby the non-import files are substantially on a single hierarchical level immediately below the consolidated import file.

### DESCRIPTION OF THE DRAWINGS

FIG. 1 is a block diagram of a representative hierarchy of program structure of the prior art, particularly illustrating multiple levels in its hierarchy;

FIG. 2 is a block diagram of one embodiment of the present invention, illustrating the hierarchy of the program, and utilizing the concept of an import file; and

FIG. 3 is a block diagram of the hierarchy of FIG. 2 after flattening.

### DETAILED DESCRIPTION OF THE PREFERRED EMBODIMENTS

Programmers are well aware that long and complex programs that are written can be difficult to write without creating at least some loops in the code which result in errors and which require debugging. When tests are created to simulate large scale integrated circuit operation, the sheer size of the effort is so large that debugging can be a formidable task. Successful code writing or coding requires a functional hierarchy be followed, which is typically in the form of a tree. Subroutines can be written and be placed in libraries and be called in the program, but such importation must be carefully implemented to prevent unwanted loops being created which can result in the program hanging up or otherwise malfunctioning.

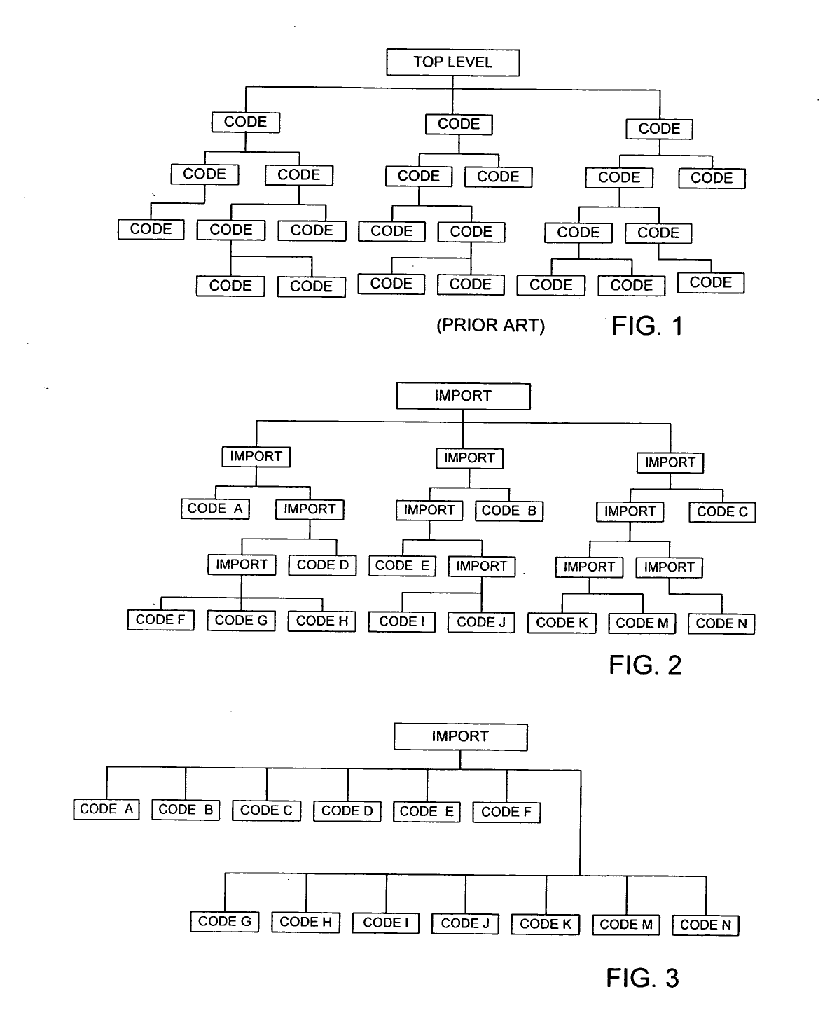

A typical hierarchy as may be produced in the prior art is shown in FIG. 1, which includes a top level file, from which branches of code emanate on several levels. Each block in the prior art represents code and/or data that is used to perform the functionality of the software.

In the preferred embodiment of the present invention, some restrictions are forced by introducing the concept of an import-type file. Thus, if any importing of other files is to occur, only an import file has that capability. If a file is an import file, it has no other purpose or capability other than to import other files. Therefore, there cannot be any functional code or useful data in an import file, other than the code which imports another file.

As is shown in FIG. 2, the concept of an import file produces the realization that in the structure of a tree, the top level file is necessarily an import file and there may be other import files under that top level file and similarly through other levels. However, once a file other than an import file is encountered, it is a given that there will never be another import file below it.

Therefore, if one examines the tree from the top level down, at some level, the end of all branches will be non-import files having non-import code and the top levels will be import files.

A problem that is normally encountered in the process of writing code involves the debugging operation. When one attempts to fix errors or to locate problems, there is often no easy way to go through a whole list of files and determine which files may have performed a file import. This is a manual recursive searching operation that is time consuming and tedious. Another way to attempt to more efficiently debug the code is to write a script that parses all of the files for a suspected problem. However, this process also results in much time being wasted.

In the preferred embodiment, before the code is ever run, a script is written to parse the whole hierarchical tree to flatten it out to have a single import file underneath which each code and data file will be located. The result is one top level import file and a lower level containing all of the non-import code and data files. From a functional point of view, nothing has changed as to how the code works, i.e., the flattened hierarchy is independent of the way in which the code works. However, a significant advantage is that the location all of the code files is easily determined as well as the contents of each file.

This enables one to more easily debug the software, because all of the code is in one place and can be easily found. It is located in the main top level file after the flattening has been done.

The manner in which the files are stored is independent of the manner in which they are run. The files are preferably stored in a hierarchical manner, because it is probably easier to find a particular file in the hierarchy rather than in a single list of hundreds if not thousands of files. This enables one to more easily find those files that pertain to changes that one wants to make. For example, in a network switch having a plurality of ports, if changes are to be made relating to ports, a port directory could have a list of files relating to ports which can be accessed and changed. When a simulation of a circuit is run, it does not matter where the files are. It is only necessary to know whether a file is an import file or a code file.

Import files are defined by a naming convention, which is preferably <filename>_import.e, and every non-import file cannot end in import. If an import file is examined, the only operational code and preferably the only code in it are import statements. The import naming convention in the e language is the keyword “import”, i.e., “import <filename>”. In other languages it may be different, such as “require <filename>”, for example.

An overview of the operation in which the preferred embodiment of the present invention is useful is a simulation environment comprising a set of tools, i.e., scripts, programs or applications that take the design of an integrated circuit such as an ASIC, and use the stimulus together with the design language and the verification language. They are pulled together to run the simulation. Results files are outputted as a product of the simulation. The results files are then typically parsed to determine whether the simulation passed or failed the test.

The preferred embodiment uses a program called runsim that runs the design and verification code. The runsim program reads in a test case and finds all of the files it needs to find and determines what command it needs to run in terms of Verilog and what command it needs to run the e code and combines those into an executable command and runs that command on one or more computers.

Before the test is run, runsim performs the flattening of the hierarchy, and then runs the test. After the simulation test is run, the two programs Verilog and e printout results files, from which data can be parsed to locate errors. If errors are found, a fail file is created with a particular test, otherwise a pass file is created. If errors are found, then debugging can be done by accessing the flattened non-import code files, which are all on the same level. The runsim tool restructures the code to simplify any debugging that may be necessary.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method of flattening a tree-like hierarchical software program structure having multiple levels that import files from other locations, comprising the steps of:
parsing said program structure to identify each instance in which the program imports code from another location in said program structure;
creating an import file for each instance in which code is imported, each import file containing code that is operational to only import code from another location; and
consolidating all import files into a consolidated import file, whereby said non-import files are substantially on a single hierarchical level immediately below said consolidated import file.

2. A method as defined in claim 1 wherein said software program structure defines a high level verification language program.

3. A method as defined in claim 2 wherein each of said import files has a unique term in its identification that indicates that it functions only as an import file.

4. A method as defined in claim 3 wherein said unique term is the string “_import” at the end of the filename, and before the “.e” extension.

5. A method as defined in claim 4 wherein a representative name of an import file in the e high level verification language program is <filename>_import.e, wherein <filename> can have varied content and length.

6. A method as defined in claim 3 wherein each import file contains only code which performs an import function.

7. A method as defined in claim 1 wherein said non-import files additionally comprises data files.

8. A method of configuring a more than two level tree-like hierarchical software program structure of the type which has files containing code that performs functional operations except importing other code, files containing code that performs functional operations including importing other code, and data files into a two level hierarchical program structure, comprising the steps of:
reconfiguring each file that includes code that imports code from another file into at least two hierarchical files, one of which comprises the code that performs the functional operations, and the other of which comprises an import file that has a single function of importing the code that performs the functional operations; and
consolidating all import files into a consolidated import file, whereby said files containing code that performs functional operations and said data files are substantially on a single hierarchical level immediately below said consolidated import file.

9. A method as defined in claim 8 wherein said reconfiguring step comprises:
parsing said program structure to identify each instance in which the program imports code from another file in said program structure;
creating an import file for each instance in which code is imported, each import file containing code that is operational to only import code from another location.

10. A computer program product comprising a computer usable medium having computer readable program code embodied in the medium for controlling the computer to:
configure a more than two level tree-like hierarchical software program structure of the type which has files containing code that performs functional operations except importing other code, files containing code that performs functional operations including importing other code, and data files into a two level hierarchical program structure, by performing the steps of:
reconfiguring each file that includes code that imports code from another file into at least two hierarchical files, one of which comprises the code that performs the functional operations, and the other of which comprises an import file that has a single function of importing the code that performs the functional operations; and
consolidating all import files into a consolidated import file, whereby said files containing code that performs functional operations and said data files are substantially on a single hierarchical level immediately below said consolidated import file.

11. A computer program product comprising a computer usable medium having computer readable program code embodied in the medium for controlling the computer to:
convert a multiple level tree-like hierarchical software program structure to a flattened condition, by performing the steps of:
parsing said program structure to identify each instance in which the program imports code from another location in said program structure;
creating an import file for each instance in which code is imported, each import file containing code that is operational to only import code from another location; and
consolidating all import files into a consolidated import file, whereby said non-import files are substantially on a single hierarchical level immediately below said consolidated import file.
